(19) United States
(12) Patent Application Publication
(10) Pub. No.: US 2021/0292512 A1
(43) Pub. Date: Sep. 23, 2021

(54) SUBSTITUTED CATECHOLS AS COVERING AND COUPLING AGENTS FOR SILICA FILLERS

(71) Applicants: Li Jia, Hudson, OH (US); Xuesong Yan, Cuyahoga Falls (US); Gary Hamed, Cuyahoga Falls, OH (US)

(72) Inventors: Li Jia, Hudson, OH (US); Xuesong Yan, Cuyahoga Falls (US); Gary Hamed, Cuyahoga Falls, OH (US)

(21) Appl. No.: 16/348,266

(22) PCT Filed: Nov. 8, 2017
(86) PCT No.: PCT/US2017/060535

§ 371 Date: May 8, 2019

Related U.S. Application Data
(60) Provisional application No. 62/418,854, filed on Nov. 8, 2016.

(51) Int. Cl. C08K 3/36; C08K 5/13; C08L 19/00; C08K 5/372; C08K 9/04

(52) U.S. Cl. CPC C08K 3/36; C08K 5/13; C08K 9/04; C08K 5/372; C08L 19/00

(57) ABSTRACT

A vulcanizable rubber composition is includes a silica filler and a substituted catechol moiety. The substituted catechol moiety having a catechol end group with an organic substituent at the 3 or 4 position of the catechol ring, the organic substituent including a hydrocarbon moiety bound to the catechol ring and having at least 2 carbons.

### CROSS-REFERENCE TO RELATED APPLICATIONS

This application claims the benefit of U.S. Provisional Patent Application Ser. No. 62/418,854, filed Nov. 8, 2016.

### STATEMENT REGARDING FEDERALLY SPONSORED RESEARCH OR DEVELOPMENT

This invention was made with government support under NSF IIP-1160982, awarded by National Science Foundation. The government has certain rights in the invention.

### FIELD OF THE INVENTION

The present invention resides in the art of silica fillers and, in some embodiment, relates to rubber compositions including silica fillers. In more particular embodiments, this invention also relates to vulcanizable rubber compositions with silica fillers having substituted catechol as an addition and, in other embodiments, relates to the modification of silica fillers with substituted catechols for use in vulcanizable rubber compositions.

### BACKGROUND OF THE INVENTION

Silica fillers have become an indispensable part of technological solutions for rubber reinforcement as an alternative to carbon black. Particularly for high performance tires, silica fillers can potentially provide low rolling resistance, reduced abrasive wear, and improved wet-skid resistance in comparison to carbon black. These advantages are only realized when the silica filler is mixed with rubber in the presence of surface-modifying silane agents under appropriate processing conditions. Without surface modification, strong hydrogen-bond interactions of the surface silanol groups between silica particles make them difficult to disperse. Even after dispersion, the silica particles still have a strong tendency to re-aggregate in a nonpolar hydrocarbon matrix, a phenomenon termed filler flocculation. The existence of aggregates is detrimental as it lowers fuel efficiency and causes poor wear resistance of tires.

Bifunctional silanes such as bis[3-(triethoxysilyl)propyl] tetrasulfide (TESPT) are the most effective and most widely used surface modifiers for tire applications. They covalently modify the surface of silica particles and form covalent linkages with the rubber during mixing and/or vulcanization and therefore are often called coupling agents. Monofunctional silanes such as 1-(triethoxysilyl)octane (OTES) also improve dispersion and suppress filler flocculation. These monofunctional silanes only modify the silica surface to make it hydrophobic or less hydrophilic and improve the surface compatibility of the silica particles with rubber in the conventional sense like silanes used to hydrophobitize glass surfaces. They are referred to as covering agents or shielding agents.

Petrochemical-derived silane surface coupling agents undesirably emit ethanol as a volatile organic compound during rubber processing. Coupling and covering agents that reduce or eliminate the need for such petrochemical-derived agents are needed in the art. Recent work has reported catechol-functionalized rubber to improve rubber-silica interaction (U.S. Pat. No. 9,051,455), and the present invention discloses unique uses for substituted catechols as coupling and covering agents for silica filler.

### SUMMARY OF THE INVENTION

In a first embodiment, the present invention provides a vulcanizable rubber composition comprising: a silica filler; and a substituted catechol moiety having the following formula:

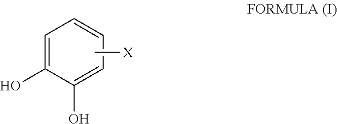

wherein X is an organic substituent at the 3 or 4 position of the catechol ring and includes a hydrocarbon moiety bound to the catechol ring and having at least 2 carbons.

In a second embodiment, the present invention provides a vulcanizable rubber composition as in any embodiment above, wherein X is a hydrocarbon moiety having 2 to 30 carbons.

In a third embodiment, the present invention provides a vulcanizable rubber composition as in any embodiment above, wherein X is a saturated hydrocarbon.

In a fourth embodiment, the present invention provides a vulcanizable rubber composition as in any embodiment above, wherein X is a pentadecyl group such that the substituted catechol moiety has the formula:

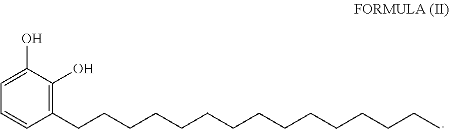 [SMILES: CCCCCCCCCCCCCCCc1cccc(O)c1O]

In a fifth embodiment, the present invention provides a vulcanizable rubber composition as in any embodiment above, wherein the substituted catechol moiety has the formula:

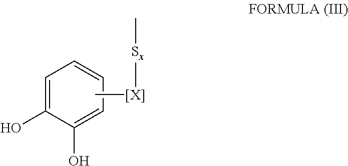

wherein x is 1 or greater.

In a sixth embodiment, the present invention provides a vulcanizable rubber composition as in any embodiment above, wherein X is a hydrocarbon moiety having 2 to 30 carbons.

In a seventh embodiment, the present invention provides a vulcanizable rubber composition as in any embodiment above, wherein the Sx moiety links to X in another substituted catechol moiety of Formula (I), thus providing a dimerized or oligomerized catechol structure.

In an eighth embodiment, the present invention provides a vulcanizable rubber composition as in any embodiment above, wherein X is a hydrocarbon moiety having 2 to 30 carbons.

In a ninth embodiment, the present invention provides a vulcanizable rubber composition as in any embodiment above, wherein X has 15 carbon atoms.

In a tenth embodiment, the present invention provides a silica filler surface-modified by chemical interaction with a substituted catechol moiety having the following formula:

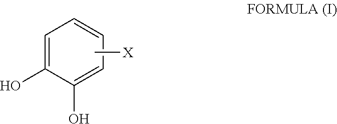

wherein X is an organic substituent at the 3 or 4 position of the catechol ring and includes an hydrocarbon moiety bound to the catechol ring and having at least 2 carbons.

In an eleventh embodiment, the present invention provides a silica filler as in any embodiment above, wherein X is a hydrocarbon moiety having 2 to 30 carbons.

In a twelfth embodiment, the present invention provides a silica filler as in any embodiment above, wherein X is a saturated hydrocarbon.

In a thirteenth embodiment, the present invention provides a silica filler as in any embodiment above, wherein X is a pentadecyl group such that the substituted catechol moiety has the formula:

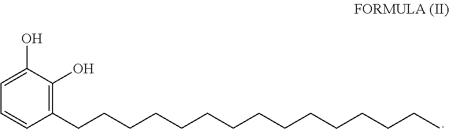 [SMILES: CCCCCCCCCCCCCCCc1cccc(O)c1O]

In a fourteenth embodiment, the present invention provides a silica filler as in any embodiment above, wherein the substituted catechol moiety is:

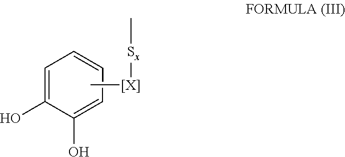

wherein x is 1 or greater.

In a fifteenth embodiment, the present invention provides a silica filler as in any embodiment above, wherein X is a hydrocarbon having 2 to 30 carbons.

In a sixteenth embodiment, the present invention provides a silica filler as in any embodiment above, wherein the Sx moiety links to X in another substituted catechol moiety of Formula (I), thus providing a dimerized or oligomerized catechol structure.

In a seventeenth embodiment, the present invention provides a silica filler as in any embodiment above, wherein X is a hydrocarbon having 2 to 30 carbons.

In an eighteenth embodiment, the present invention provides a silica filler as in any embodiment above, wherein X has 15 carbon atoms.

In a ninteenth embodiment, the present invention provides a method for making a modified silica filler for rubber reinforcement, the method comprising the steps of: mixing silica filler and a substituted catechol in an alcohol that dissolves the catechol; and agitating the mixture of said step of mixing, the catechol having a substituted catechol moiety:

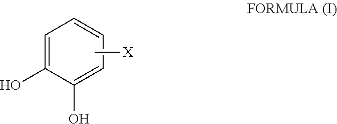

wherein X is an organic substituent at the 3 or 4 position of the catechol ring and includes an hydrocarbon moiety bound to the catechol ring and having at least 2 carbons.

In a twentieth embodiment, the present invention provides a method of forming a coupling agent for silica fillers for rubber comprising the steps of: combining substituted catechols and sulfur in an inert atmosphere, wherein the substituted catechols include the substituted catechol moiety:

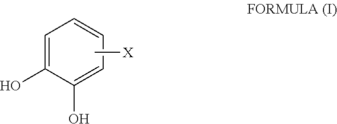

wherein X is an organic substituent at the 3 or 4 position of the catechol ring and includes a hydrocarbon moiety bound to the catechol ring and having at least 2 carbons, with at least one of said two carbons being unsaturated; and heating to a temperature of at least 120° C. wherein said step of heating introduces multi-sulfidic bonds between said substituted catechols by reaction of sulfur at at least some of the unsaturated carbons of the substituted catechols.

### BRIEF DESCRIPTION OF THE DRAWINGS

FIG. 1 shows the hydrogenation of urushiol, an example of a catechol useful in this invention;

FIG. 2 shows the sulfurization of urushiol, an example of a catechol useful in this invention;

FIG. 3 illustrates a proposed mechanism for surface modification of a silica filler by a substituted catechol, particularly hydrogenated urushiol;

FIG. 4 illustrates a proposed mechanism for surface modification of a silica filler by a substituted catechol, particularly sulfurized urushiol;

FIG. 5 is a table of rubber formulations in a Hydrogenated Urushiol experiment summarized herein; and

FIG. 6 is a table of rubber formulations in a Sulfurized Urushiol experiment summarized herein.

### DETAILED DESCRIPTION OF ILLUSTRATIVE EMBODIMENTS

The present invention discloses the use of substituted catechols as additions to vulcanizable rubber compositions including silica fillers. In other embodiments, the present invention discloses the use of substituted catechols as surface modifiers for silica fillers to be used in rubber compositions or in other formulations benefiting from the use of silica filler coupling or covering agents. In yet other embodiments, the present invention provides methods for surface modifying silica filler with a substituted catechol. This invention also provides coupling agents and methods of forming coupling agent for silica fillers, the coupling agents being substituted catechols linked by sulfur linkages.

In a first embodiment, this invention provides vulcanizable rubber compositions including silica filler and a substituted catechol moiety:

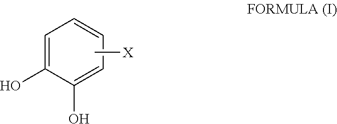

wherein X is an organic substituent at the 3 or 4 position of the catechol ring and includes an alkyl moiety bound to the catechol ring and having at least 2 carbons.

The rubber component can be virtually any rubber component or rubber mixture subject to vulcanization processes. The rubber is not focused upon as it will be chosen according to general practices, but perhaps the most commercially employed are styrene-butadiene and butadiene rubbers, and the present invention has application for suc specific rubbers.

The silica fillers can also selected from virtually any known silica filler. In some embodiments, the silica filler has silicon atoms available for chemical interaction with the catechols according to this invention.

In some embodiments, the silica fillers are selected from highly dispersable silica, highly dispersable micropearl silica, precipitated silica, or amorphous precipitated silica. In particular embodiments, the silica fillers are selected from highly dispersable micropearl silica.

In some embodiments, the silica fillers are selected from Zeosil® by Solvay, Effricium® by Solvay, Ultrasil® by Evonik Industries AG, or Hi-Sil® by PPG Industries, Inc. In particular embodiments, the silica fillers are selected from Zeosil® 1165MP by Solvay.

The substituted catechol moiety is described most broadly above in Formula (I). In particular embodiments, the substituted catechol moiety is provided by a hydrogenated substituted catechol (HC), while, in other embodiments, the substituted catechol moiety is proved by a sulfurized substituted catechol (SC). In some embodiments, a mixture of HC and SC may be employed in the vulcanizable rubber composition. HC has been found to serve as a covering agent, modifying the surface of silica such that it is more hydrophobic and more compatible with the rubber matrix. SC has been found to serve as a coupling agent between silica and rubber, providing multi-sulfidic bonds that can subsequently form covalent linkages between rubber and silica. Use of modified silica and/or substituted catechol in vulcanizable rubber compositions in accordance with this invention allows a reduction of TESPT usage while maintaining or slightly improving dynamic mechanical attributes and tear resistance. The partial replacement of TESPT by substituted catechol has potential environmental benefits because catechols, particularly in the form of urushiol, are a renewable resource and do not introduce volatile organic compounds during processing.

In some embodiments, the substituted catechol moiety is provided by a hydrocarbon-substituted catechol (HC) including a catechol end group and a hydrophobic tail (—X) according to Formula (I):

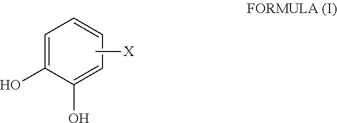

wherein X is an alkyl at the 3 or 4 position of the catechol ring having at least 2 carbons. In some embodiments, X is saturated and has from 2 or more to 30 or less carbons.

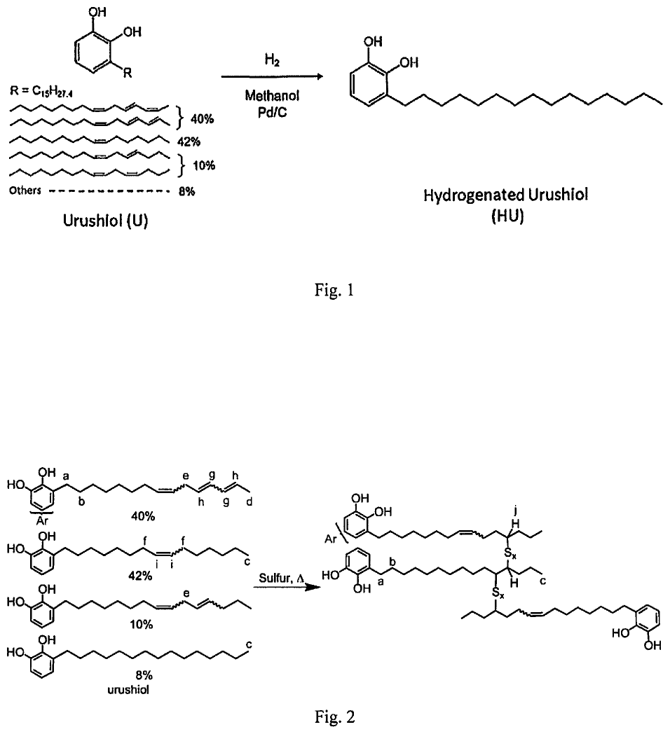

As generally depicted in a specific embodiment shown in FIG. 1, substituted catechol having an unsaturated tail can be hydrogenated by exposure of the substituted catechol to a hydrogen (H2) atmosphere using a Pd/C catalyst. The substituted catechol having unsaturated tail is dissolved in an appropriate solvent, such as an alcohol solvent (methanol in FIG. 1), and the catalyst placed therein. The atmosphere can be purged with an inert, dry atmosphere such as by purging with N2, and then hydrogen is bubbled through the solvent. This can be carried out a room temperature. The solution can be exposed to hydrogen for at least 1 hour, and the resulting product filtered to remove the catalyst. After removing the solvent, the residual wax can be crystalized in hexane, yielding crystals of hydrogenated catechol.

In some embodiments, X is saturated and has 15 carbons, herein termed “hydrogenated urushiol” (HU) which can be produced from natural urushiol sources.

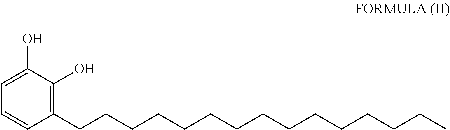 [SMILES: CCCCCCCCCCCCCCCc1cccc(O)c1O]

Urushiol is an oily mixture of catechol species with different degrees of unsaturation, which, for purposes of this disclosure, can be generally represented at the left in FIG. 1. The 8% estimated as “Others” can include fully saturated hydrogenated urushiol such as that shown at the right. FIG. 1 and the disclosure above provide the process for making hydrogenated urushiol.

In some embodiments, the substituted catechol moiety is a sulfurized-hydrocarbon substituted catechol moiety according to Formula (III):

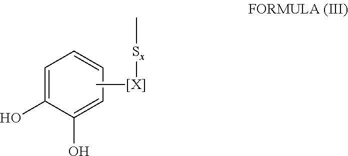

wherein X is an organic substituent at the 3 or 4 position of the catechol ring and includes a hydrocarbon moiety bound to the catechol ring and having at least 2 carbons, and x is 2 or greater. The bracketing around X is to represent that the S_{X} moiety can be bound anywhere along the length of X. In some embodiments, X is from 2 or more to 30 or less carbons.

In some embodiments, the substituted catechol moiety is provided by a sulfurized-hydrocarbon substituted catechol of the following formula:

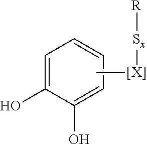

wherein X is an organic substituent at the 3 or 4 position of the catechol ring and includes a hydrocarbon moiety bound to the catechol ring and having at least 2 carbons, and x is 1 or greater. The bracketing around X is to represent that the S_{X} moiety can be bound anywhere along the length of X. In some embodiments, X is from 2 or more to 30 or less carbons. R is hydrogen or an organic or inorganic group. In some embodiments x is 2 or greater.

In some embodiments, the substituted catechol moiety is provided by a sulfurized substituted catechol (SC), with multi-sulfidic bonds between substituted catechol moieties, the multi-sulfidic bonds permitting the subsequent formation of covalent linkages between rubber and silica. A sulfurized substituted catechol is represented by Formula (IV):

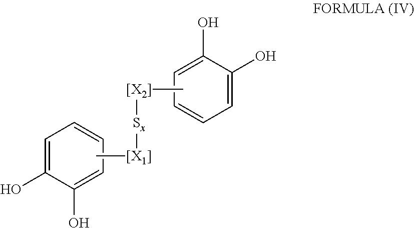

wherein X₁ and X₂ are the same or different and are selected according to X above, and x is 1 or greater. In some embodiments x is 2 or greater. The bracketing around X₁ and X₂ represents that the S_{X} moiety can be bound anywhere along the length of X₁ and X₂. In sulfurized substituted catechol, the S_{X} moiety links between substituted catechol moieties of Formula (I), thus providing a dimerized or oligomerized catechol structure. In some embodiments, X₁ and X₂ may be the same or different and have from 2 or more to 30 or less carbons.

As generally depicted in a specific embodiment shown in FIG. 2, sulfur linkages can be introduced between substituted catechols having an unsaturated tail by simply heating the substituted catechols and sulfur. Heating is preferably carried out in an inert atmosphere such as nitrogen.

In some embodiments, the sulfurized substituted catechol is formed from urushiol, as in FIG. 2, and is termed herein “sulfurized urushiol” (SU). It will be appreciated that FIG. 2 is a simplified expression of urushiol sulfurization. As already mentioned, urushiol is readily sourced from natural sources.

In vulcanizable rubber compositions, the substituted catechol moiety can be introduced by in situ incorporation of one of the HC or SC compounds above into an otherwise common vulcanizable rubber composition having appropriate matrix rubbers, fillers (including particularly silica), coupling agents (which class includes the SC/SU coupling agents taught herein), covering agents (which class includes the HC/HU covering agents taught herein). extenders, plasticizers antioxidants, activators, curing agents, and accelerators. Upon the addition and reaction of curing agents, the composition begins to transition from a vulcanizable rubber composition to a vulcanized rubber composition.

In a particular process, matrix rubbers are first added to a mixer. Thereafter silica fillers (and any other desired fillers) are added with extenders and any desired coupling agents and/or covering agents. After further mixing, plasticizer and activators, such as stearic acid and zinc oxide, are then added and mixing continues and temperature increases. The mixture is dumped typically at a temperature below 170° C. After optional storage and mixing steps, the antioxidants, curing agent (e.g., sulfur) and accelerators are added and mixed to achieve a vulcanized rubber product.

It will be appreciated that the in situ incorporation of the substituted catechol moiety into vulcanized rubbers involves employing substituted catechols, HC and/or SC, as full or partial substitutes for more common coupling agents (such as TESPT) and covering agents. As such, the various ingredients of the vulcanizable rubber compositions are formulated according to known and common amounts, while the substituted catechols will be employed in similar parts per hundred rubber as compared to the coupling agents and/or covering agents they are replacing, when used alone. When used as only a partial substitute for common coupling agents and covering agents, the total parts per hundred rubber of the substituted catechols of this invention and the common coupling agents and/or covering agents will be similar to the part per hundred rubber (phr) typically employed in the prior art when using common coupling and/or covering agents.

In some embodiments, when used alone as a coupling agents, SC is employed at from 0.5 to 12 phr. In some such embodiments, SC is used at from 1 to 7 phr, and, in yet other embodiments, from 7 to 9 phr. When SC is used in conjunction with other common coupling agents, such as TESPT, the SC to common coupling agent ratio based on parts per hundred rubber is from about 1:20 to about 20:1, and, in other embodiments, from about 2:3 to about 3:2.

In some embodiments, when used alone as a covering agents, HC is employed at from about 0.5 to about 12 phr. In some such embodiments, HC is used at from about 1 to about 7 phr, and, in yet other embodiments, from about 7 to about 9 phr. When HC is used in conjunction with common coupling agents, such as TESPT, the HC to common covering agent ratio based on parts per hundred rubber is from about 1:10 to about 10:1 and, in other embodiments, from about 1:3 to about 3:1.

This invention also provides modified silica fillers and methods for modifying silica fillers with substituted catechols. In one embodiment, this invention provides a silica filler surface-modified by chemical interaction with a substituted catechol moiety:

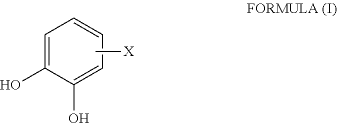

wherein X is an organic substituent at the 3 or 4 position of the catechol ring and includes an alkyl moiety bound to the catechol ring and having at least 2 carbons.

The silica can be chosen as descried above in the disclosure of vulcanizable rubber compositions.

The substituted catechol moiety is described most broadly above in Formula (I). In particular embodiments, the substituted catechol moiety is provided by a hydrogenated substituted catechol (HC), while, in other embodiments, the substituted catechol moiety is proved by a sulfurized substituted catechol (SC). These are all adequately disclosed above.

This invention provides a method for making a modified silica filler with the substituted catechols disclosed herein. The method includes mixing silica filler and a substituted catechol in an alcohol that dissolves the substituted catechol; and agitating that mixture, the catechol having a substituted catechol moiety

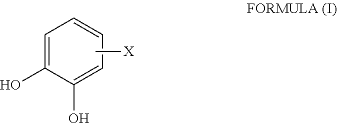

wherein X is an organic substituent at the 3 or 4 position of the catechol ring and includes an alkyl moiety bound to the catechol ring and having at least 2 carbons. In some embodiments, an amine is added to the suspension to act as a catalyst. In some embodiments, this suspension is sonicated. In particular embodiments, the substituted catechol moiety is provided by a hydrogenated substituted catechol (HC), while, in other embodiments, the substituted catechol moiety is proved by a sulfurized substituted catechol (SC). These are all adequately disclosed above.

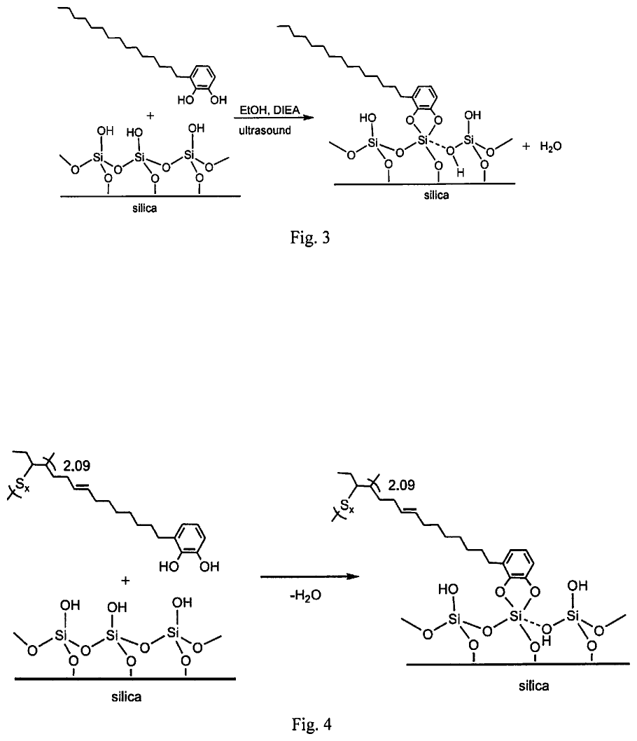

It is envisioned that the catechol moiety will replace one equivalent of water and form a chelating complex with surface silicon, for example, as shown in FIGS. 3 and 4. Note that silicon complexes with catechol ligands are usually 5- or 6-coordinate instead of 4-coordinate. This bonding propensity can be potentially accommodated by coordination of an adjacent OH group to the silicon. Of course, other bonding modes between the catechol group and silicon atom are possible. Catechol bonding to surface oxides is an ongoing topic of study in the literature in the context of catechol-based adhesion but remains an open question at this point. Seló J, Saiz-Poseu J, Busqué F, and Ruiz-Molina D. Catechol-Based Biomimetic Functional Materials, Advanced Materials 2013; 25:653-701.

However, in developing this invention, it was found that the surface of silica particles became more hydrophobic after the above modification method. It was also found that the allergenic potency of the urushiol was lost or greatly diminished. This supports the type of bonding posited above and in FIGS. 3 and 4, wherein, due to the aliphatic tail of hydrogentated urushiol, in the case of FIG. 3, and due to the hydrocarbon moieties in the structure of the sulfurized urushiol, in the case of FIG. 4, a hydrophobic surface is expected. It would further be expected that urushiol should completely lose its allergenic potency after interaction with silica as in FIGS. 3 and 4.

It has been found that the degree of surface coverage of the silica by the substituted catechol can be controlled by adjusting the concentration of the substituted catechol and the base during surface modification. With the theory as expressed in FIGS. 3 and 4, the degree of surface coverage is to be understood as the degree to which silicon atom cites remain unbound to catechol moieties. When partially covered, it has been found the modified silica filler can be used in combination with other coupling agents, and particularly TESPT. This is particularly true with hydrogenated substituted catechol.

These modified silica fillers can be used as a partial or full replacement for the silica fillers now used in various industries where silica needs to be made more compatible to a matrix material. The modified silica fillers of this invention can be used in amounts commensurate with the current use of prior art unmodified silica fillers in a given article of manufacture, such as, for example, vulcanizable rubber compositions. The various ingredients of a vulcanizable rubber compositions can be formulated according to known and common amounts, while the modified silica fillers will be employed in similar parts per hundred rubber as compared to the use of prior art unmodified silica filler. When used as only a partial substitute for prior art unmodified silica fillers, the total parts per hundred rubber of the modified silica fillers of this invention and the prior art unmodified silica fillers will be similar to the part per hundred rubber (phr) typically employed in the prior art when using prior art unmodified silica filler.

Is should be noted that the modified silica fillers can be used as an alternative to or in combination with in situ incorporation of substituted catechols.

In light of the foregoing, it should be appreciated that the present invention significantly advances the art. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

### EXAMPLES

### Silica Filler Modified with Hydrogenated Urushiol

### Materials

Hexane, methanol, ethanol, di[3-(triethoxysilyl)propyl] tetrasulfide (TESPT), sulfur and N-diisopropylethylamine (DIEA) were purchased from Alfa Aesar and used without purification. Palladium on carbon (Pd/C, 10 wt %) was purchased from Sigma-Aldrich. Hydrogen was purchased from Praxair Inc. Urushiol was supplied by Guoqi Co., Ltd., Wuhan, Hubei, China. SBR containing 27.3 wt % heavy naphthenic oil (SLF30H41), BR (BUD 1207), silica (Zeosil 1165MP), naphthenic oil, wax, antioxidant and accelerator were donated by Goodyear Tire & Rubber Company. Stearic acid and zinc oxide were donated by Akrochem Co.

### Chemical Structure Characterization

1H NMR measurements were performed on a Varian Mercury 300 MHz instrument. 1H chemical shifts were determined using the CHC13 peak as reference.

### Synthesis of Hydrogenated Urushiol (HU)

Pd/C (10 g) was placed in a Schlenk flask. The flask was evacuated and back-filled with N2. Urushiol (100 g) was dissolved in methanol (500 mL) in a 1-L round-bottom Schleck flask. The methanol solution of urushiol was transferred into the Schleck flask slowly under N2 flow. The mixture was stirred with a magnetic stirrer during the transfer process to prevent the Pd/C from becoming a solid piece. H2 was bubbled into the suspension for 12 h at room temperature. The suspension was filtered under N2 to remove Pd/C. After methanol was removed from the solution under vacuum, a wax resulted and was crystallized with hexane or methanol (˜1.6 L) at −10° C. The resulting brown crystals were collected after filtration and dried under vacuum (yield 90 g, 90%). 1H NMR (CDCl3): δ 0.89 (t, J=7.0 Hz, 3H), 1.25 (bm, 24H), 1.64 (m, 2H), 2.61 (t, 7.6 Hz, 2H), 6.71 (m, 3H) ppm. 13C{1H} NMR (CDCl3): δ18.1, 22.0, 22.2, 22.4, 22.6, 23.1, 24.4 28.2, 115.1, 115.4, 120.4, 137.8, 141.2, 143.6 ppm. HRMS (ESI) m/z: Calcd. For C21H36O2: 320.5101[M]+, Found: 320.5123.

### Preparation of Surface-Modified Silica HUMS10

HU (10.0 g, 31.2 mmol) was dissolved in 600 ml of ethanol. SiO2 (100 g) was added into the flask. The suspension was stirred with a magnetic stirrer briefly at room temperature. Then, DIEA (2.0 mL, 21 mmol) was added into the flask. After sonication at 100 Watt at room temperature for 3 h, the mixture was centrifuged. The gray precipitate was washed with ethanol and centrifuged again. The resulting product was dried in a vacuum oven (yield 82 g, 82%).

### Preparation of Surface-Modified Silica HUMS05

The same procedure as described above for HUMS10 was applied except that only 10% HU (1.00 g, 3.12 mmol) and DIEA (0.2 mL, 2 mmol) were used (yield 78 g, 78%).

### Rubber Compounding

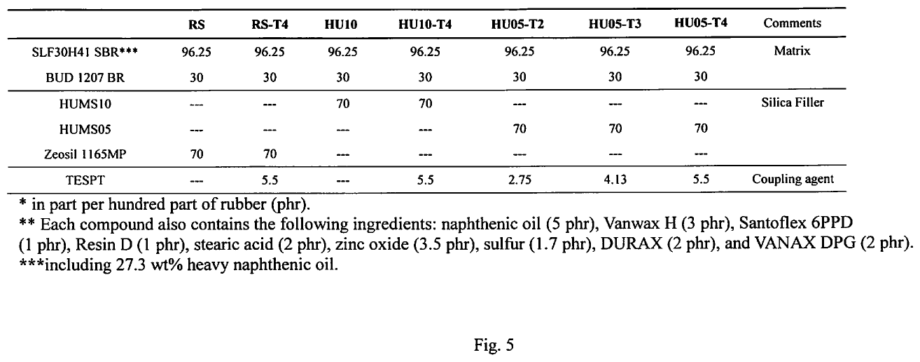

The rubber formulations are summarized in the table provided in FIG. 5. The green compounds were formed by a common 3-step mixing procedure. In the first step, matrix rubbers were first added into a research scale Brabender mixer (80 cm3) with a rotor speed of 60 rpm and an initial temperature of 90° C. After 1 min of mixing, a mixture of silica filler, processing oil and coupling agent was added into the mixer. At the 4th min, plasticizer, stearic acid and zinc oxide were added. As temperature increased to 160° C., rotor speed was adjusted between 45-65 rpm to maintain 160° C. for 5 min. The total mixing time in this step was 13-15 min, and the dump temperature was 160° C. The compound was collected and stored in a refrigerator overnight. In the second step, the compound was added back into the mixer with no other materials added. The initial temperature was 90° C. The compound was mixed for 6 min at the rotor speed of 60 rpm and then dumped at 160° C. The resultant compound was collected and stored in a refrigerator for 5 h. In the third step, the compound was added into mixer and mixed at the rotor speed of 35 rpm and initial temperature of 55° C. After 1 min, antioxidants, sulfur and accelerators were added into the mixer. The total mixing time in this step was 6 min, and the dump temperature was 90° C. The final compound was milled to a flat sheet at 60° C. on a two-roll mill with the roll-to-roll distance set at 1 mm. The rubber sheets were placed in sealed plastic bags and stored at −45° C. if not used immediately.

### Conclusions

Studies from these reductions to practice have shown that hydrogenated urushiol can be readily grafted onto silica particles in ethanol suspension in the presence of a tertiary amine as catalyst. The degree of surface coverage can be controlled by the concentrations of hydrogenated urushiol and the base. When silica is completely covered by hydrogenated urushiol (i.e., silica HUMS10), it has a high propensity to be dispersed in rubber matrix. Mooney viscosity and Payne effect studies of the uncured rubber compounds indicate that the dispersion of HUMS10 in the absence of TESPT is as effective as dispersion of standard unmodified silica in the presence of TESPT under otherwise identical mixing conditions. Bound rubber test has shown that the rubber-filler interaction in the HUMS10-rubber composite is weak. Filler flocculation at the early stage of vulcanization remains significant. Payne effect of the vulcanizate containing HUMS10 (i.e., HU10) and loss factor above room temperature remain high in comparison to the reference vulcanizate containing TESPT and unmodified silica (i.e., RS-T4). In addition, TESPT proves ineffective with HUMS10 since the surface is preoccupied.

When partially covered by hydrogenated urushiol (i.e., silica HUMS05), silica fillers can be used in combination with TESPT. Overall, Payne effect, dynamic loss factors at 0 and 60° C., tensile strength, and cut resistance displayed by the vulcanizates reinforced by HUMS05 in the presence of various amounts of TESPT (i.e., the HUM series) are in proximity to those of the reference vulcanizate, RS-T4. Particularly, HU05-T3, which contains 75% as much of TESPT as RS-T4 does, has identical tan [symbol] s at 0° C. and 60° C. but reduced Payne effect and improved cut resistance in comparison to RS-T4.

Hydrogenated urushiol is therefore an effective surface-covering agent. Judicial combination of a covering agent and a coupling agent can result in optimal physical interactions and covalent bonds between the silica filler and the rubber matrix and consequently optimal properties of the resultant vulcanizate. Reduction in the use of petrochemical-derived silane surface coupling agents through the use of biorenewable urushiol derivatives is not only desirable from the point of view of sustainability but also reduces emission of ethanol as a volatile organic compound during rubber processing.

### Suflurized Urushiol

### Materials

Bis [3-(triethoxysilyl)propyl] tetrasulfide (TESPT), N-ethyldiisopropylamine (DIEA), sulfur, and ethanol were purchased from Alfa Aesar. Urushiol was purchased from Guoqi Co., Ltd., China. SBR, butadiene rubber, silica, extender oil, wax, antioxidant and accelerator were donated by Goodyear Tire & Rubber Company. Stearic acid and zinc oxide were donated by Akrochem.

### Chemical Structure Characterization

1H NMR measurements were performed on a Varian Mercury 300 MHz instrument. 1H chemical shifts were determined using the CHCl3 peak as reference.

### Study of Sulfurizing Urushiol

Urushiol (25.0 g, 78.0 mmol) and sulfur (5.0 g, 156 mmol) were added into a Schleck flask. The flask was filled with nitrogen on a Schlenk line and heated in an oil bath at the temperature of interest. The reaction mixture was stirred during heating and sampled periodically. The samples (˜2 g) were added into a vial containing 20 mL ethanol to extract the product and unreacted urushiol, if any. Unreacted elemental sulfur, which is not soluble in ethanol, was removed by filtration. Ethanol was then removed under vacuum. The nonvolatile substance after ethanol removal was subjected to elemental analysis to determine the amount of sulfur incorporation.

### Preparation of Sulfurized Urushiol (SU)

Urushiol (25.0 g, 78.0 mmol) and sulfur (5.00 g, 156 mmol) were added into a Schleck flask. The flask was filled with nitrogen on a Schlenk line. The reaction mixture was heated and stirred for 3 h in an oil bath at 140° C. After cooling to room temperature, the flask was evacuated to remove any H2S that might be present. The resultant product was a thick black oil (25 g, 100%).

### Cleavage of Multi-Sulfidic Bonds in SU

SU (1.91 g, 5 mmol catechol) was placed in a Schleck flask. The flask was evacuated and back-filled with nitrogen on a Schlenk line. Piperidine (50 mL) was added into the flask. After SU was completely dissolved, n-butylthiol (4.51 g, 50 mmol) was added into the solution. The reaction was stirred at room temperature for 24 h. n-Butylthiol and piperidine were removed under vacuum to yield dSU.

### Preparation of SU-Modified Silica (SUMS)

SU (10 g, 31.25 mmol) was dissolved in 600 mL of ethanol in a round-bottom flask. Zeosil 1165 MP silica (100 g) was added into the flask. The suspension was stirred with a magnetic stirrer. Then, N-ethyldiisopropylamine (2.0 mL, 21 mmol) was added into the flask. The stirrer was then removed, and the mixture was sonicated at room temperature for 3 h. The resultant suspension was centrifuged. The gray precipitate were washed with ethanol and centrifuged two more times. The product was dried in a vacuum oven (yield 72 g, 72%).

### Size Exclusion Chromatography (SEC)

The molecular weight of SU was measured using a Tosoh HLC-8320GPC with two TSK-GEL SuperH3000 columns and one TSKGEL SuperH5000 column equipped with a refractive index detector. THF was used as the eluent at 40° C. The flow rate was 0.350 mL/min. THF solutions of urushiol and SU (4 mg/mL) were prepared and filtered through 2 mm microfilters before injection. The molecular weight was determined relative to polystyrene standards.

### Rubber Compounding

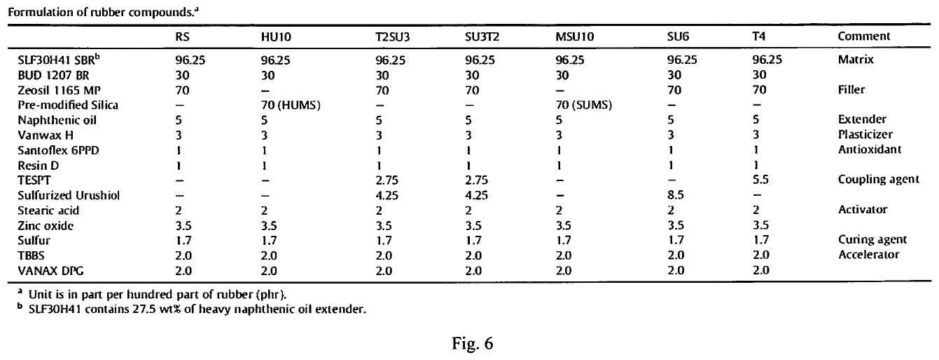

The rubber compound recipes are summarized in the table presented in FIG. 6. All compounds were formed by a 3-step mixing process. In the first step, the matrix rubbers were added into a Brabender mixer (80 cm3) at a rotor speed of 60 rpm and initial temperature of 90° C. After 1 min of mixing, silica filler, processing oil and coupling agent were added into the mixer. At the 4th min, plasticizer, stearic acid and zinc oxide were added. As temperature increased to 160° C., the rotor speed was adjusted between 45 and 65 rpm to maintain 160° C. for 5 min. The total mixing time was 13-15 min, and the dump temperature was 160° C. The compound was stored in a refrigerator overnight. In the second step, the compound was added back into the mixer. The initial temperature was 90° C. The compound was mixed for 6 min at 60 rpm and dumped at 160° C. The resultant compound was stored in a refrigerator for 5 h. In the third step, the compound was added into the mixer at an initial temperature of 55° C. and mixed at 35 rpm. After 1 min mixing, antioxidants, sulfur and accelerators were added into the mixer. The total mixing time in this step was 6 min, and the dump temperature was 90 C. The final compound was milled to a flat sheet at 60° C. on a two-roll mill with the roll-to-roll distance set at 1 mm.

Modification of Silica Fillers with SU

Surface modification of silica particles can be achieved using two methods, pre-modification in a suspension and reactive mixing in an internal mixer. Here, after treatment with SU in the presence of diisopropylethyl-amine (DIEA) as catalyst, the silica surface was completely hydrophobitized. The surface-water contact angle of the resultant SU-modified silica (SUMS) was estimated to be ˜90°. The chemical reaction on the surface presumably involves chelation of catechol to silicon upon replacement of water and an oxo ligand (FIG. 4).

### Compounding and In Situ Modification of Silica by SU

The rubber compounds were all prepared using a common 3-step mixing process as detailed in Experimental Section (see FIG. 6 for rubber compound designations). Compounds RS, T4, and HU10 are references for comparison with test compounds MSU10, SU6, SU3T2, and T2SU4. RS is reinforced with unmodified silica filler, T4 contains TESPT, and HU10 is reinforced by silica filler premodified with hydrogenated urushiol [18]. Among the test samples, MSU contained silica fillers pre-modified by SU. In all other test compounds, SU was added directly into the internal mixer and mixed with silica filler and other ingredients. The silica filler was modified in situ in these compounds as was the reference T4. The total molar amounts of surface active groups (i.e., catechol and (EtO)3Si— groups) are the same in these instances, and the weight amounts in phr differ by a factor of the ratio of the molecular weights of the surface active agents. To avoid unwanted reactions between the catechol functionality and the (EtO)3Si— functionality, SU and TESPT were added in separate mixing steps in SU3T2 and T2SU3. For SU3T2, SU was added in step 1, and TESPT was added in step 2; and vice versa for T2SU3.

### Mooney Viscosity

Mooney viscosity studies of uncured compounds were carried out to evaluate the ability of SU to disperse silica either by premodification or in situ modification of silica. The rubber samples were studied immediately after mixing and after storage under ambient conditions for 13 days. The ML(1+4) values are summarized in FIG. 4. All compounds that contain a surface modifying agent display reduced ML(1+4) values compared with RS. Among them, MSU10, which contains SUMS (i.e., silica pre-modified by SU), has the highest ML(1+4). The high viscosity of MSU10 may be attributable to interparticle covalent linkages formed by SU during pre-modification of the silica particles in suspension as we observed precipitation of chunks of silica. In contrast, precipitation was never observed when the monofunctional HU was used to premodify silica under otherwise identical conditions. When silica was directly compounded with SU, the viscosity of SU6 is significantly lower than that of MSU10 and comparable to that of T4. The above comparison suggests that in situ modification of silica with bifunctional coupling agents, at least for SU, is superior to premodification. Note that the ML(1+4) values of SU6 and T4 are still slightly higher than that of HU10, again likely as the result of interparticle covalent linkages formed by TESPT and SU. The formation of interparticle linkages by bifunctional coupling agents was suggested by Lin et al. in their study of bifunctional and monofunctional silanes (Lin C J, Hergenrother W, Alexanian E, and Bohm G. On the filler flocculation in silica-filled rubbers part I. Quantifying and tracking the filler flocculation and polymer-filler interactions in the unvulcanized rubber compounds, Rubber chemistry and technology 2002; 75:865-890).

### CONCLUSIONS

These reductions to practice show that sulfurized urushiol (SU) can be synthesized in one step by simply heating sulfur and urushiol at 140° C. The multi-sulfidic structure in SU was studied by the means of thiolsulfide interchange reaction. SEC result shows that 53% of the linkages between the urushiol unit in SU are multi-sulfidic. The presence of breakable S—S bonds qualifies SU as a coupling agent. Modification of silica with SU is effected either in a premodification step or in situ during compounding. Direct compounding is the preferred method not only for convenience but also performance. Mooney viscosity and Payne effect studies of the uncured rubber compounds show that SU is as effective as TESPT to promote filler dispersion during mixing. The increased bound rubber content and suppressed filler flocculation demonstrate that SU indeed generates covalent filler-rubber linkages during mixing in contrast to our previously reported hydrogenated urushiol, which only acts as a covering agent. However, SU is somewhat less effective than TESPT as a coupling agent. The dynamic mechanical properties of the SU-containing vulcanizate are intermediate between the TESPT-containing standard and the hydrogenated urushiol-containing standard. When SU is used to replace 50% TESPT, all aspects of the vulcanizate are essentially preserved, with slight improvements in cut resistance, Payne effect, and loss factor at 0° C. but slight sacrifice in loss factor at 60° C. An important advantage of the urushiol derivative-based surface modifying agent over alkoxylsilanes is that the former produces water as the byproduct while the latter produces a volatile organic compound, ethanol.

What is claimed is:

1. A vulcanizable rubber composition comprising:
a silica filler; and
a substituted catechol moiety having the following formula: 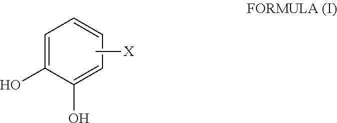
wherein X is an organic substituent at the 3 or 4 position of the catechol ring and includes a hydrocarbon moiety bound to the catechol ring and having at least 2 carbons.

2. The vulcanizable rubber composition of claim 1, wherein X is a hydrocarbon moiety having 2 to 30 carbons.

3. The vulcanizable rubber composition of claim 2, wherein X is a saturated hydrocarbon.

4. The vulcanizable rubber composition of claim 3, wherein X is a pentadecyl group such that the substituted catechol moiety has the formula:

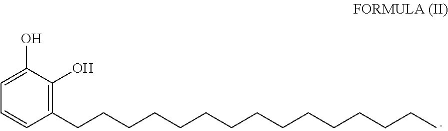 [SMILES: CCCCCCCCCCCCCCCc1cccc(O)c1O]

5. The vulcanizable rubber composition of claim 1, wherein the substituted catechol moiety has the formula: 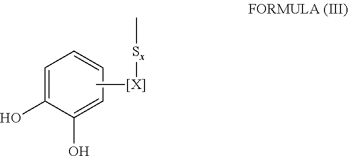
wherein x is 1 or greater.

6. The vulcanizable rubber composition of claim 5, wherein X is a hydrocarbon moiety having 2 to 30 carbons.

7. The vulcanizable rubber composition of claim 5, wherein the S_{X} moiety links to X in another substituted catechol moiety of Formula (I), thus providing a dimerized or oligomerized catechol structure.

8. The vulcanizable rubber composition of claim 7, wherein X is a hydrocarbon moiety having 2 to 30 carbons.

9. The vulcanizable rubber composition of claim 8, wherein X has 15 carbon atoms.

10. A silica filler surface-modified by chemical interaction with a substituted catechol moiety having the following formula: 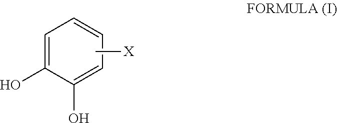
wherein X is an organic substituent at the 3 or 4 position of the catechol ring and includes an hydrocarbon moiety bound to the catechol ring and having at least 2 carbons.

11. The silica filler of claim 10, wherein X is a hydrocarbon moiety having 2 to 30 carbons.

12. The silica filler of claim 11, wherein X is a saturated hydrocarbon.

13. The silica filler of claim 12, wherein X is a pentadecyl group such that the substituted catechol moiety has the formula:

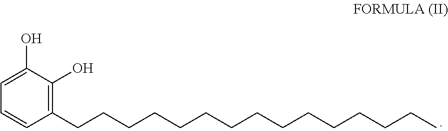 [SMILES: CCCCCCCCCCCCCCCc1cccc(O)c1O]

14. The silica filler of claim 10, wherein the substituted catechol moiety is: 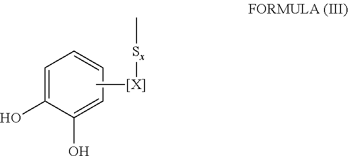
wherein x is 1 or greater.

15. The silica filler of claim 14, wherein X is a hydrocarbon having 2 to 30 carbons.

16. The silica filler of claim 14, wherein the Sx moiety links to X in another substituted catechol moiety of Formula (I), thus providing a dimerized or oligomerized catechol structure.

17. The silica filler of claim 16, wherein X is a hydrocarbon having 2 to 30 carbons.

18. The silica filler of claim 17, wherein X has 15 carbon atoms.

19. A method for making a modified silica filler for rubber reinforcement, the method comprising the steps of:
mixing silica filler and a substituted catechol in an alcohol that dissolves the catechol; and
agitating the mixture of said step of mixing, the catechol having a substituted catechol moiety 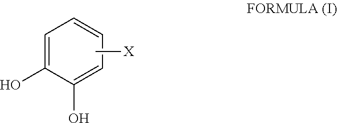
wherein X is an organic substituent at the 3 or 4 position of the catechol ring and includes an hydrocarbon moiety bound to the catechol ring and having at least 2 carbons.

20. A method of forming a coupling agent for silica fillers for rubber comprising the steps of:
combining substituted catechols and sulfur in an inert atmosphere, wherein the substituted catechols include the substituted catechol moiety: 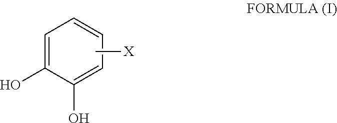
wherein X is an organic substituent at the 3 or 4 position of the catechol ring and includes a hydrocarbon moiety bound to the catechol ring and having at least 2 carbons, with at least one of said two carbons being unsaturated; and
heating to a temperature of at least 120° C. wherein said step of heating introduces multi-sulfidic bonds between said substituted catechols by reaction of sulfur at at least some of the unsaturated carbons of the substituted catechols.
